(19) United States
(12) Patent Application Publication
(10) Pub. No.: US 2015/0378786 A1
(43) Pub. Date: Dec. 31, 2015

(54) PHYSICAL RESOURCE ALLOCATION

(71) Applicants: Adarsh SUPARNA, (US); Ajeya H. SIMHA, (US); HEWLETT-PACKARD DEVELOPMENT COMPANY, L.P., Houston, TX (US)

(72) Inventors: Adarsh Suparna, Bangalore (IN); Ajeya H Simha, Bangalore (IN)

(21) Appl. No.: 14/761,567

(22) PCT Filed: Jan. 31, 2013
(86) PCT No.: PCT/IN2013/000065

§ 371 Date: Jul. 16, 2015

(51) Int. Cl. G06F 9/50

(52) U.S. Cl. CPC G06F 9/5005; G06F 9/5016; G06F 9/5027

(57) ABSTRACT

Allocation of physical resources is achieved by accessing consumption data for each of a plurality of application components executing in one or more virtual machines and consuming a plurality of allocated physical resources. The consumption data is indicative of consumption levels by each of the plurality of application components of each of the plurality of physical resources. Following a determination that a value for a performance metric associated with the application has crossed an associated threshold value, the consumption data is analyzed to identify a consumption level of a first of the plurality of physical resources being consumed by a first of the plurality of application components has deviated from a historical trend for that physical resource. An instruction is then communicated that when executed will cause a change in an allocation level of the first of the plurality of physical resources.

### BACKGROUND

Cloud computing can be implemented by a data center to stand up public and private clouds. Cloud computing offers self-service, scalability, and elasticity, along with additional advantages of control and customization that were not traditionally possible. Cloud service providers extend service level agreements (SLAs) that define guaranteed levels of application performance. For example, SLAs may specify performance metrics defining response times or computations per time frame. Application performance is then monitored to ensure SLA compliance.

### DRAWINGS

FIG. 1 depicts an example environment in which various embodiments could be implemented.

FIG. 2 depicts a system according to an example.

FIG. 3 is a block diagram depicting a memory resource and a processing resource according to an example.

FIG. 4 is a flow diagram depicting steps taken to implement an example.

FIG. 5 is an example graph illustrating performance metric values for an application measured over time.

FIGS. 6 and 7 are example graphs depicting physical resource consumption levels for two application components.

### DETAILED DESCRIPTION

Introduction:

Modern applications include multiple components that operate together to achieve a desired result. In one example an application may include an application server and a database server. One or more instances of each component can execute in any number of virtual machines. When executed, each component consumes physical resources such as CPU, memory, networking and storage. Because, multiple virtual machines can share access to the same physical resources, proper resource allocation many times is needed to ensure desired application performance.

Cloud service providers extend service level agreements (SLAs) that define guaranteed levels of application performance. SLAs may specify performance metrics defining response times or computations per time frame. Manual monitoring can prove difficult and in many cases inefficient or simply ineffective. While a performance metric such as an average response time can be visualized and a breach of a corresponding SLA identified, it can be difficult to quickly determine the bottleneck that causing the undesired performance. Bottlenecks, often occur when a physical resource allocated to a virtual machine is being consumed by an application component at higher than expected level. It can be difficult if not impossible to manually identify the application component and corresponding physical resource causing a bottleneck especially as the number of virtual machines increases.

Various embodiments described below have been developed to automatically allocate physical resources to virtual machines executing application components. In one example, performance data and consumption data are acquired from agents executing in the virtual machines. The performance data is indicative of a performance metric over time for the application. The consumption data is indicative of physical resource consumption levels over time by each application component or virtual machine. The performance data is analyzed to identify a performance event. A performance event occurs when a value for a performance metric associated with the application crosses an associated threshold value. For example, where the performance metric corresponds to an application response time, the threshold value may correspond to a particular average response time dictated or determined by an SLA. In one example, crossing a threshold value indicates that an SLA has or is likely to be breached and that an application component may need to be allocated additional physical resources. In another example, crossing a threshold value indicates that performance levels are well within SLA requirements and a physical resource is being underutilized and may be allocated away from an application component.

Upon detecting that a performance metric has crossed a threshold, the consumption data is analyzed to examine the consumption levels of physical resources utilized by the application components. Where the consumption level of one of the physical resources (but not another) deviates from a historical trend at a time generally coinciding with the performance event, it can be presumed that the given application component consuming that physical resource caused the performance event. An instruction is communicated, that when executed will cause a change in an allocation level of that corresponding physical resource. The instruction, for example, may be communicated to and executed by a cloud controller responsible for managing the virtual machines executing the various application components. Where the performance event indicates an actual or likely SLA breach, the change in resource allocation may be an increase intended to cause the performance metric value to cross back over the threshold. Where the performance event is indicative of an underutilization, the change in allocation may be a decreased allocation allowing the physical resource to be reallocated elsewhere.

In this fashion physical resources can be automatically allocated and reallocated to both help ensure SLA compliance and efficient resource consumption.

The following description is broken into sections. The first, labeled “Setting,” describes an environment in which various embodiments may be implemented. The second section, labeled “Components,” describes examples of various physical and logical components for implementing various embodiments. The third section, labeled “Operation,” describes steps taken to implement various embodiments.

Setting:

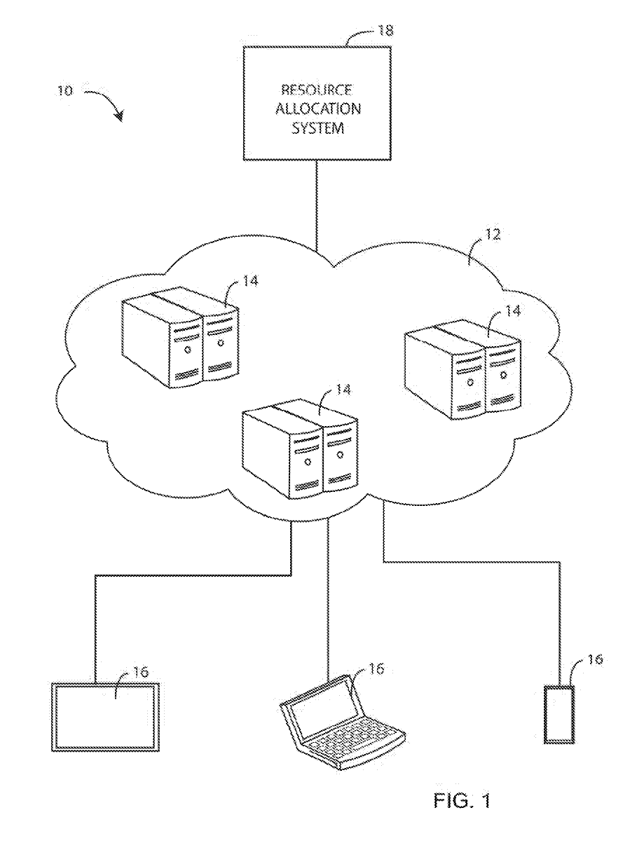

FIG. 1 depicts a setting 10 in which various embodiments may be implemented. Setting 10 is shown to include cloud environment 12, physical resources 14, client computing devices 16, and resource allocation system 18. Cloud environment 12 represents generally computing resources (hardware and software) configured to be provided as a service over a network such as the Internet. Physical resources 14, depicted for efficiency purposes as servers, supply the CPU, memory, networking, and storage resources needed to implement cloud environment. Users are provided access to application software and databases executing in the cloud environment while a cloud provider manages the infrastructure and platforms on which the applications run. In the example of FIG. 1, that infrastructure is represented by physical resources 14.

A cloud controller (not shown) is responsible for provisioning physical resources 14 to the various components of an application. In doing so, the controller utilizes physical resources 14 to instantiate virtual machines for executing the application components. The virtual machines share physical resources such as CPU, memory, networking, and storage provided by physical resources 14 with a specified portion of each resource allocated to each virtual machine. Together, two or more virtual machines may be referred to herein as a virtual environment.

Client devices 16 represent generally any computing devices capable of utilizing applications provided within cloud environment 12. Resource allocation system 18, described in detail below, represents a system configured to automatically manage the allocation of resources being consumed by the components of an application executing in cloud environment 12. In general, resource allocation system 18 is configured to in response to a predetermined performance event, identify a consumption level of a physical resource being consumed by an application component that has spiked or otherwise experienced a change generally corresponding in time with the performance event. System 18 then communicates an instruction that when executed by a cloud controller causes a change in allocation of that resource according to the nature of the performance event. For example, where the performance event is an actual or likely breach of an SLA, the change may be an increased allocation of the resource to its corresponding application component.

Components:

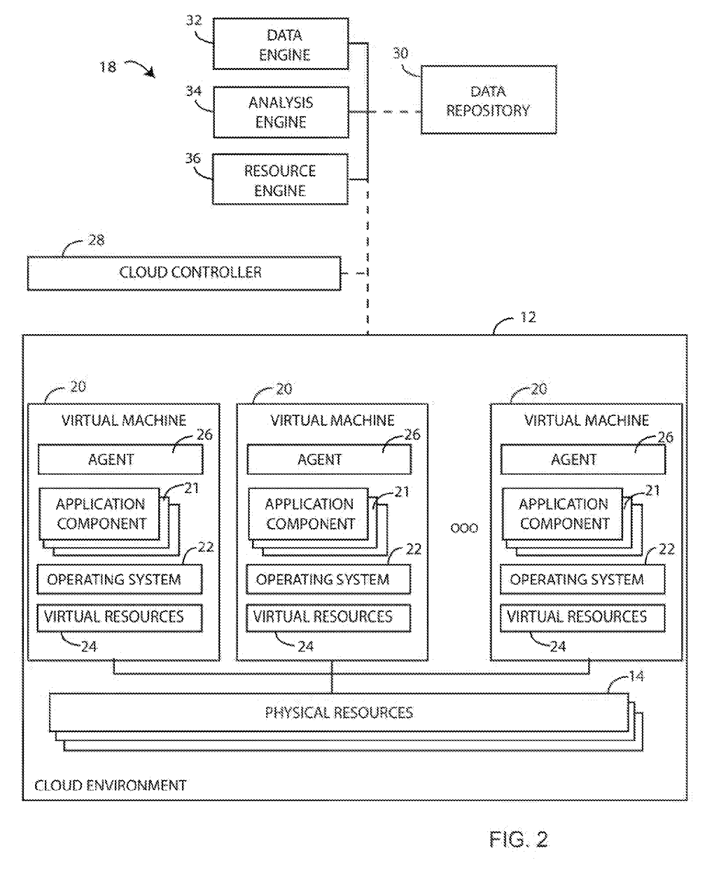

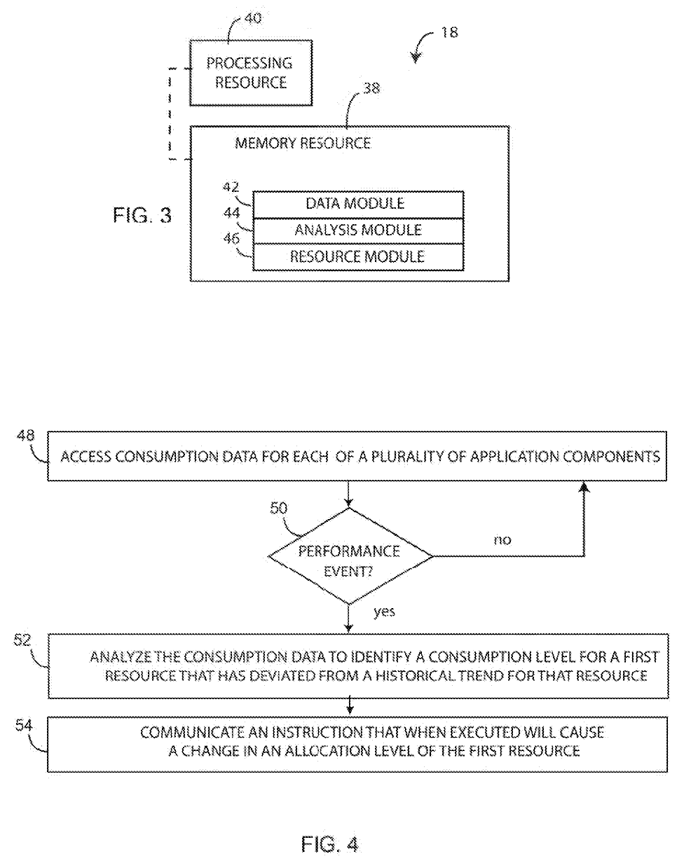

FIGS. 2 and 3 depict examples of physical and logical components for implementing various embodiments. In FIG. 2 various components are identified as engines 32-36. In describing engines 30-34, focus will be on each engine's designated function. However, the term engine, as used herein, refers to a combination of hardware and programming configured to perform a designated function. As is illustrated later with respect to FIG. 3, the hardware of each engine, for example, may include a processor and a memory, while the programming is code stored on that memory and executable by the processor to perform the designated function. In another example, the hardware may be the memory used to store the code.

FIG. 2 depicts resource allocation system 18 in communication with cloud environment 12. In this example, cloud environment 12 includes physical resources 14 and is shown to include a number of instantiated virtual machines 20 each executing one or more application components 21 on top of corresponding operating systems 22. For an example application, various components 21 may represent different application servers and various instances of any given application server. Likewise, other components 21 may represent different database services and different instances of any particular database server. Each virtual machine 20 includes virtual resources 24. Virtual resources 24 for a given virtual machine 20 represent that virtual machine's allocation of physical resources 14. Again, these physical resources can include CPU, memory, networking, and storage resources. Each virtual machine 20 is also shown as executing an agent 26. Each agent 26 is configured to monitor a performance metric, a physical resource consumption level, or combinations thereof for a given virtual machine 20 or application component 21. Each agent 26, depending on its purpose, is configured to generate data indicative of either or both a monitored performance metric and monitored physical resource consumption level and to communicated that data to or otherwise make it available to resource allocation system 18. Such data can be referred to as performance statistics and consumption statistics.

FIG. 2 also depicts cloud controller 28. Cloud controller 28 is responsible for executing an instruction received from resource allocation system 18 to change an allocation level of a specified physical resource. That change may be either an increase or a decrease in the level of the physical resource allocated to a given virtual machine 20 or application component 21. Cloud controller 28 may have other functions such as instantiating, replicating, porting, and closing virtual machines 20. In other words, cloud controller 20 is configured to scale applications up or down by managing resource allocation levels and to scale in or out by closing or replicating virtual machines 20. As depicted, cloud controller 28 is independent of cloud environment 28 and represents a combination of hardware and programming configured to implement the functions specified above. In other examples, cloud controller 28 may be part of cloud environment 12 and implemented by one or more application components 21 executing in one or more virtual machines 20.

Resource allocation system 18 is shown to be in communication with data repository 30 and cloud controller 28 and cloud environment 12. Data repository represents generally any physical memory accessible to system and configured to store performance data and consumption data. While shown as being distinct of cloud environment 12, resource allocation system 18 may be may be part of cloud environment 12 and implemented by one or more application components 21 executing in one or more virtual machines 20.

Resource allocation system 18 is shown to include data engine 32, analysis engine 34, and resource engine 36. Data engine 32 is configured to maintain performance data and resource consumption data. The performance data is indicative of a performance metric trend for an application. The application includes a plurality of application components 21 executing in one or more virtual machines 20. The consumption data is indicative of consumption level trends for each of a plurality of physical resources 14 being consumed by the plurality of application components. In the example of FIG. 2, data engine 32 may perform this function by acquiring data from agents 26 storing that data in data repository 30. Thus, the performance and consumption data represent a performance metric value and physical resource consumption level values measured over time.

Agents 26 may continuously or periodically report performance and consumption measurements and data engine 32 may take collect that information in one or more tables or other data structures within data repository 30. Data engine 32 may also maintain parameters associated with a service level agreement (SLA) for an application. The parameters may specify one or more thresholds corresponding to performance metrics such as transaction performance (response times) or transaction volume. For example, one threshold may specify an average response time that, if exceeded, the SLA is or is in danger of being breached. Another threshold may specify an average response time that if not exceeded indicates that physical resources 14 currently allocated to a given component 21 of the application can be reallocated and used more efficiently to support another application component 21.

Analysis engine 34 is configured to analyze the performance data to determine if a performance metric value for an application has crossed an associated threshold value. Such may be referred to as a performance event. In response to a positive determination, analysis engine 34 is responsible for analyzing the consumption data to identify a consumption level of one of the plurality of physical resources being consumed by a given component of the application has deviated from a historical trend for that resource. Analysis engine 34 may only consider a deviation that generally coincided in time with the given performance event. In other words, analysis engine 34 may only look for deviations that share a predetermined time frame or window with the performance event and can be presumed to be a cause of the performance event. A historical trend can thus be determined at least in part by maximum and minimum consumption levels occurring during a period before corresponding performance event.

Resource engine 36 is configured to communicate an instruction that when executed by cloud controller 28 will cause a change in an allocation level of the physical resources identified by analysis engine 34. The instruction may be in a markup language format such as XML (eXtensible Mark-up Language). In performing its function, resource engine 36 may examine the current consumption level of the identified physical resource and its recent consumption trend to optimize the change. The optimization may result in an increase or a decrease depending on the situation and can affect fewer than all of the physical resources allocated to the application components. Such is true when analysis of the consumption data reveals that a consumption level of another of the plurality of physical resources being consumed by a component of the application has not deviated from a historical trend for that resource. Thus the instruction when executed only affects the allocation level of a resources identified in the analysis of the consumption data.

In an example, the performance event corresponds to an actual or likely breach of an SLA. Here, optimization results in an instruction that when executed by cloud controller 28 increases the current allocation level of the resource in an amount expected to bring the performance metric value back in line with the SLA sot that it is not being breached or not a path to be breached. Execution of that instruction is also expected not to over-allocate and leave the physical resource underutilized. In another example, the performance event is indicative of resource underutilization. Here, optimization results in an instruction that when executed by cloud controller 28 decreases the current allocation level of the resource in an amount that allows the physical resource to be more efficiently used elsewhere without breaching the SLA.

To summarize, resource allocation system 18, with the aid of agents 26, monitors the performance of an application implemented by one or more virtual machines 20 within cloud environment 12. Upon detecting a performance event, system 18 automatically identifies a change in consumption level of a physical resource supporting the application where that change coincided in time with the performance event. System 18 then automatically communicates an instruction that when executed by cloud controller 28 causes a change in allocation level of the identified physical resource. Depending on the nature of the performance event, the change may be an increase or a decrease.

Resource allocation system 18 may also be configured to predict future performance events and take action in an attempt to prevent them from occurring. Over time, data engine 32 may maintain details concerning performance events and consumption data corresponding in time to those events. These details may be referred to as past performance and consumption data. Analysis engine 34 can then process the past performance data to predict an occurrence of a future performance event. Past performance data may reveal repeated periods such as time of day or a day of the week or a month that a performance event is likely to occur absent a change in a resource allocation level. Thus, a future performance event may be predicted to occur during that same time the following day, week, or month as the case may be.

Analysis engine 34 can then analyze the past consumption data to identify a predicted future variance in a consumption level of a given physical resources predicted to correspond in time with the with the future performance event. The past consumption data may reveal that the consumption level for a given physical resource deviates from a historical trend at a time corresponding to a past performance event. Resource engine 36 can then communicate an instruction that when executed will cause a change in an allocation level of the resource whose consumption level is predicted to deviate. The instruction will be communicated such that it can be executed during or before the predicted future performance event.

In foregoing discussion, engines 32-36 were described as combinations of hardware and programming. Engines 32-36 may be implemented in a number of fashions. Looking at FIG. 3, the programming may be processor executable instructions stored on tangible memory resource 38 and the hardware may include processing resource 40 for executing those instructions. Thus memory resource 38 can be said to store program instructions that when executed by processing resource 40 implement system 18 of FIG. 2.

Memory resource 38 represents generally any number of memory components capable of storing instructions that can be executed by processing resource 40. Memory resource 38 is non-transitory in the sense that it does not encompass a transitory signal but instead is made up of more or more memory components configured to store the relevant instructions. Memory resource 38 may be implemented in a single device or distributed across devices. Likewise processing resource 40 represents any number of processors capable of executing instructions stored by memory resource 38. Processing resource 40 may be integrated in a single device or distributed across devices. Further, memory resource 38 may be fully or partially integrated in the same device as processing resource 40, or it may be separate but accessible to that device and processing resource 40.

In one example, the program instructions can be part of an installation package that when installed can be executed by processing resource 40 to implement system 18. In this case, memory resource 38 may be a portable medium such as a CD, DVD, or flash drive or a memory maintained by a server from which the installation package can be downloaded and installed. In another example, the program instructions may be part of an application or applications already installed. Here, memory resource 38 can include integrated memory such as a hard drive, solid state drive, or the like.

In FIG. 3, the executable program instructions stored in memory resource 38 are depicted as data module 42, analysis module 44, and resource module 46. Data module 42 represents program instructions that when executed cause processing resource 40 to implement data engine 32 of FIG. 2. Analysis module 44 represents program instructions that when executed cause the implementation of analysis engine 34. Likewise, resource module 46 represents program instructions that when executed cause the implementation of resource engine 36.

Operation:

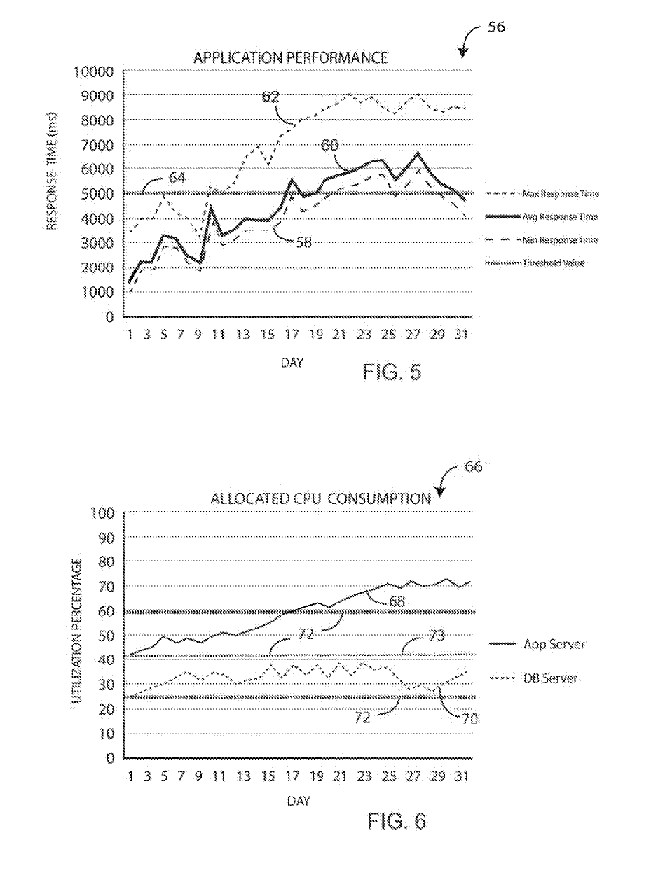

FIG. 4 is a flow diagram of steps taken to implement a method for allocating physical resources. FIGS. 5-7 depict various graphs used help illustrate example use cases. In discussing FIGS. 4-7, reference may be made to the components depicted in FIGS. 2 and 3. Such reference is made to provide contextual examples and not to limit the manner in which the method depicted by FIG. 4 may be implemented.

Referring to FIG. 4, consumption data is accessed (step 48). The consumption data is for each of a plurality of application components executing in one or more virtual machines and consuming a plurality of allocated physical resources. The consumption data is indicative of consumption levels by each of the plurality of application components of each of the plurality of physical resources implementing the one or more virtual machines. Referring to FIG. 2, data engine 32 may be responsible for implementing step 48.

A determination is made as to whether a performance event has occurred (step 50). A performance event occurs when a value of a performance metric associated with the application crosses an associated threshold value. Analysis engine 34 of FIG. 2 may implement step 50 with data engine 32 accessing the performance data analyzed to make the determination. In an example, the threshold value may correspond to a parameter set or otherwise determined according to the application's service level agreement (SLA). Here, a presumption can be made that the SLA has or is likely to be breached when the performance metric value crosses that threshold value in a given direction.

Looking ahead to FIG. 5, graph 56 depicts performance data in the form of response times over a time period for a given application. Here that performance data corresponds to a minimum, average, and maximum application response times 58, 60, and 62. Graph 56 also depicts a threshold value 64. Here a performance event may occur when the average response time 60 crosses and exceeds threshold value 64.

Moving back to FIG. 4, the consumption data is analyzed to identify a consumption level of a first of the plurality of resources being consumed by a first of the plurality of application components has deviated from a historical trend for that physical resource (step 52). The historical trend is defined at least in part by a one or more of a maximum and a minimum consumption level of a given physical resource during a period prior to the occurrence of the performance event. Referring to FIG. 2, step 52 may be implemented by analysis engine 34.

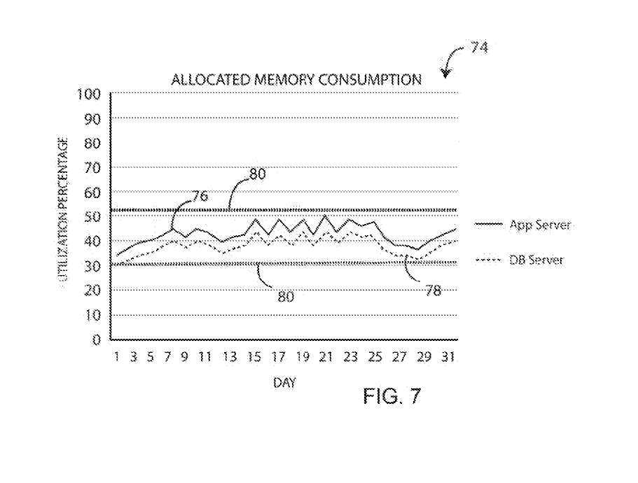

Looking ahead, graph 66 of FIG. 6 depicts CPU consumption levels 68 and 72 for two application components—an application server and a database server. Graph 74 of FIG. 7 depicts memory consumption levels 76 and 78 tor the same two components. Looking at FIG. 6, CPU consumption for the application server deviates from its historic trend defined by the space between lines 72 while CPU consumption for database server does not deviate from its historical trend defined by lines 73. Looking at FIG. 7, memory consumption for both components remains within the historical trends defined by the space between lines 80. Thus, in the example of FIGS. 6 and 7, only the consumption level 68 of CPU resources by the application server component would be identified in step 52 of FIG. 4.

Referring Back to FIG. 4, the method continues with step 54 in which an instruction is communication. That instruction, when received and executed will cause a change in an allocation level of the resource whose consumption level was identified in step 52. Referring to FIG. 2, step 54 may be implemented by resource engine 36 while cloud controller 28 may be responsible for executing the instruction. Execution may cause an increase or a decrease in allocation depending upon the nature of the performance event detected in step 50. Where the performance event corresponds to an actual or likely breach of an SLA, execution may cause an increase. Where the performance event is indicated of resource underutilization, execution bay cause a decrease. In the example of FIGS. 5-7, the instructions when executed only affect the allocation level of CPU resources for the application server.

The method of FIG. 4 can be modified to predict performance events and take action in an attempt to prevent them from occurring. Over time, details concerning performance events and consumption data corresponding in time to those events can be maintained. These details may be referred to as past performance data and consumption data. In a modified form, step 50 includes processing the past performance data to predict a future performance event. Past performance data may reveal repeated periods such as time of day or a day of the week or a month that a performance event is likely to occur absent a change in a resource allocation level. Thus, a future performance event may be predicted to occur during that same time the following day, week, or month as the case may be.

Step 52 is then modified such that the past consumption data is analyzed to identify a predicted future variance in a consumption level of a given physical resources predicted to corresespind in time with the with the future performance event. The past consumption data may reveal that the consumption level for a given physical resource deviates from a historical trend at a time corresponding to a past performance event. Finally, step 54 can be modified to communicate an instruction that when executed will cause a change in an allocation level of the first the resource whose consumption level is predicted to deviate. The instruction will be communicated such that it can be executed during or before the predicted future performance event.

Conclusion:

FIGS. 1-3 aid in depicting the architecture, functionality, and operation of various embodiments. In particular, FIGS. 2 and 3 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A memory resource storing instructions that when executed cause a processing resource to:
access consumption data for each of a plurality of application components executing in a virtual environment and consuming a plurality of allocated physical resources, the consumption data indicative of consumption levels by each of the plurality of application components of each of the plurality of physical resources; and
following a determination that a value for a performance metric associated with the application has crossed an associated threshold value:
analyze the consumption data to identify a consumption level of a first of the plurality of physical resources being consumed by a first of the plurality of application components has deviated from a historical trend for that physical resource; and
communicate an instruction that when executed will cause a change in an allocation level of the first of the plurality of physical resources.

2. The memory resource of claim 1, wherein:
the instructions that cause the processing resource to analyze include instruction that when executed cause the processing resource to analyze the consumption data to identify that a consumption level of a second of the plurality of physical resources has not deviated from a historical trend for that physical resource; and
the instructions that cause the processing resource to communicate include instruction that when executed cause the processing resource to communicate an instruction that when executed will cause a change in an allocation level of the first of the plurality of physical resources but not a change in an allocation level of the second of the plurality of physical resources.

3. The memory resource of claim 1, wherein:
the threshold value corresponds to a parameter defined in a service level agreement associated with the application;
the determination is a determination that the value for the performance metric has crossed the associated threshold value and has or is on a path to likely breach the service level agreement;
the instructions that cause the processing resource to communicate include instruction that when executed cause the processing resource to communicate an instruction that when executed will cause an change in an allocation level of the first of the plurality of physical resources to alter the value of the performance metric so that, at a third time, it is not breaching or on a path to likely breach the service level agreement.

4. The memory resource of claim 1, wherein:
the instructions include instructions, that when executed, cause the processing resource to identify a first time associated with the value for the performance metric crossing the associated threshold value; and
the instructions that cause the processing resource to analyze include instruction that when executed cause the processing resource to analyze the consumption data to identify that the consumption level of the first of the plurality of physical resources has, at a second time, deviated from a historical trend for that physical resource, the second time sharing a predetermined time fame with the first time.

5. The memory resource of claim 1, wherein:
the performance metric corresponds to an application response time;
the application components include application server and database server components;
the physical resources include, for each component, memory resources and central processing (CPU) resources of a physical computing device; and
the instructions that cause the processing resource to communicate include instruction that when executed cause the processing resource to communicate an instruction that when executed will cause a change in an allocation of one of the CPU and memory resources having the identified consumption level in an amount expected to cause the application response time to comply with a service level agreement.

6. A system, comprising a computer readable resource storing instructions that when executed cause a processing resource to implement a resource engine, a data engine, and an analysis engine, wherein:
the resource engine is configured to communicate an instruction that when executed causes a change in an allocation level for a physical resource identified by the analysis engine and allocated to a component of an application having a plurality of components each consuming a plurality of physical resources;
the data engine is configured to maintain performance data and resource consumption data, the performance data indicative of a performance metric trend for the application, the consumption data indicative of consumption level trends for each of the plurality of physical resources being consumed by the plurality of application components;
the analysis engine is configured to:
analyze the performance data to determine if a service level agreement has been or is predicted to be breached; and
analyze the consumption data to identify a first one of the plurality of physical resources for which the consumption level by a corresponding application component has experienced or is predicted to experience an increase corresponding in time to the actual or predicted breach.

7. The system of claim 6, wherein, if analysis of the consumption data does not indicate, for a second one of the plurality of physical resources, an actual or predicted consumption level increase corresponding in time to the actual or predicted breach, the analysis engine is configured to not identify the second one of the plurality of physical resources, and the instructions communicated by the resource engine, when executed, cause a change in the allocation level of the first physical resource but not a change in an allocation level of the second physical resource.

8. The system of claim 6, wherein the first of the plurality of application components executes in a virtual machines along with a monitoring agent, and wherein the data engine is configured to periodically acquire performance statistics and consumption statistics from the monitoring agent to update the performance data and consumption data.

9. The system of claim 6, wherein the resource engine is configured to communicate the instructions in a markup language format for use by a cloud controller to change the allocation level for the identified physical resource.

10. The system of claim 6, further comprising the processing resource.

11. A system for allocating physical resources to components of an application executing in a virtual environment, the system comprising an analysis engine and a resource engine:
the resource engine to communicate an instruction that when executed will cause a change in an allocation level of a first of the physical resources but not a second of the physical resources as specified by the analysis engine;
the analysis engine to, in response to a determination that a performance event as occurred with respect to the application during a time frame:
evaluate consumption levels for the first and second physical resources; and
identify that the one of the first and second physical resources but not the other has been consumed at a level that deviated from a historical trend for that physical resource during the time frame.

12. The system of claim 11:
comprising a data engine to configured to maintain performance data and resource consumption data; and
wherein the analysis engine is configured to process the performance data to identify the performance event and process the consumption data to identify the deviation.

13. The system of claim 11, wherein the resource engine is configured to:
determine an allocation level adjustment for the first of the physical resources that is expected to shift the performance metric to a desired state; and
communicate instructions that when executed will cause a change in an allocation level of the first of the physical resources according to the determined allocation level adjustment.

14. The system of claim 13, wherein:
the analysis engine is configured to process performance data to determine that a breach in a service level agreement has actually or is predicted to occur, the performance data including current and historical values for the performance metric; and
the resource engine is configured to determine an allocation level adjustment for the first of the physical resources that is expected to remedy the actual breach or prevent an occurrence of the predicted breach.

15. The system of claim 11, comprising:
a data engine configured to maintain past performance data and past resource consumption data;
the analysis engine is configured to process the past performance data to predict a future application performance event and to process the past resource consumption data to identify a predicted future variance in a consumption level of the first of the physical resources predicted to correspond in time with the future performance event; and
the resource engine is configured to communicate an instruction that when executed will cause a change in an allocation level of the first of the physical resources during or before the predicted occurrence of the future performance event for the purpose of at least partially preventing the predicted future application performance event.
